(19) United States
(12) Patent Application Publication
(10) Pub. No.: US 2013/0097054 A1
(43) Pub. Date: Apr. 18, 2013

(54) SYSTEMS AND METHODS FOR MENULESS MOBILE COMMERCE

(71) Applicant: Vendmore Systems, LLC, Stamford, CT (US)

(72) Inventors: Paul T. Breitenbach, Wilton, CT (US); Paul D. Signorelli, Ridgefield, CT (US); Igor Zhuk, Weston, CT (US); Matthew D. Breitenbach, Ridgefield, CT (US)

(73) Assignee: VENDMORE SYSTEMS, LLC, Stamford, CT (US)

(21) Appl. No.: 13/651,210

(22) Filed: Oct. 12, 2012

Related U.S. Application Data
(60) Provisional application No. 61/546,541, filed on Oct. 12, 2011.
(60) Provisional application No. 61/561,013, filed on Nov. 17, 2011.
(60) Provisional application No. 61/568,140, filed on Dec. 7, 2011.

(51) Int. Cl. G06Q 30/06

(52) U.S. Cl. 705/26.8

(57) ABSTRACT

Systems, methods, and articles of manufacture provide for menuless mobile commence.

### CROSS-REFERENCE TO RELATED APPLICATIONS

This application claims benefit and priority to, and is a non-provisional of: (i) U.S. Provisional Patent Application No. 61/546541 filed on Oct. 12, 2011 and titled “FOOD SERVICE MOBILE PLATFORM”, (ii) U.S. Provisional Patent Application No. 61/561013 filed on Nov. 17, 2011 and titled “MOBILE COMMERCE INNOVATIONS”, and (iii) U.S. Provisional Patent Application No. 61/568140 filed on Dec. 7, 2011 and titled “MOBILE COMMERCE 2.0”; the entirety of each of which is hereby incorporated by reference herein.

### BACKGROUND

The ability to order products or services from mobile devices or via the Internet in general has become commonplace for many types of businesses. Certain businesses and types of businesses, however, such as small restaurants, food vendors, and other small businesses, have been slow and sporadic in adopting such technologies.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a prior art system;

FIG. 2 is a block diagram of a prior art system;

FIG. 3 is a block diagram of a system according to some embodiments;

FIG. 4 is a block diagram of a system according to some embodiments;

FIG. 5 is a flow diagram of a method according to some embodiments;

FIG. 6 is a block diagram of an apparatus according to some embodiments; and

FIG. 7A, FIG. 7B, FIG. 7C, and FIG. 7D are perspective diagrams of exemplary data storage devices according to some embodiments.

### DETAILED DESCRIPTION

Embodiments presented herein are descriptive of systems, apparatus, methods, and articles of manufacture for menuless mobile commerce applications, such as for providing the ability and convenience of online and/or mobile device ordering with respect to merchants lacking an online presence. In some embodiments, offline vendors may be “nudged” into establishing an online presence by leveraging social media. According to some embodiments, access to online ordering for merchants that do have an online presence may be enhanced and/or simplified such as by allowing and/or enabling natural-language and/or free-form ordering.

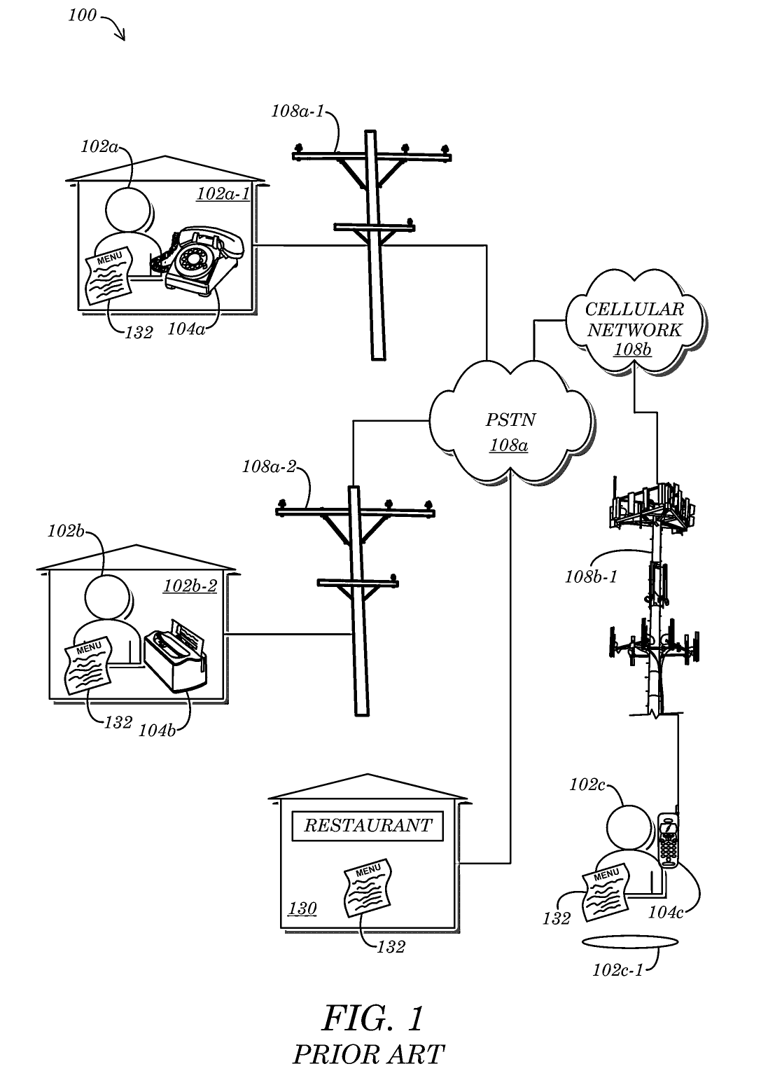

Turning first to FIG. 1, a block diagram of a prior art system 100 is shown for comparison. The prior art system 100 may, for example, represent and/or depict a typical “carry-out”, “take-out”, or other remote or wireless ordering capability common to many vendors. In some situations, for example, the prior art system 100 may comprise a plurality of customers 102a-c operating and/or associated with a respective plurality of customer devices 104a-c. In some situations, a first customer 102a and/or a second customer 102b may be located at or within a first building 102a-1 and/or a second building 102b-1, respectively. The buildings 102a-1, 102b-1 may, for example, comprise places of domicile (e.g., homes) and/or places of work (e.g., office buildings or job sites). In some situations, a third customer 102c may be located at a remote location 102c-1 (e.g., outside of any structures).

As depicted in FIG. 1, the customers 102a-c may communicate with either or both of a Public Switched Telephone Network (PSTN) 108a or a cellular network 108b. The first customer 102a may, for example, utilize the first customer device 104a (e.g., a telephone, as depicted) to communicate via a first telephone system device 108a-1 (e.g., one or more telephone poles, as depicted, and/or associated equipment). The second customer 102b may utilize the second customer device 104b (e.g., a fax machine, as depicted) to communicate via a second telephone system device 108a-2 (e.g., one or more telephone poles, as depicted, and/or associated equipment). The third customer 102c may utilize the third customer device 104c (e.g., a cellular telephone, as depicted) to communicate via a cellular network device 108b-1 (e.g., a cell tower, as depicted). In some situations, communications via the cellular network 108b may be routed and/or transferred to and/or via the PSTN 108a.

The communications of the customers 102a-c may generally comprise information descriptive of purchase orders (such as “take-out”) orders transmitted to a merchant such as a restaurant 130. As depicted in FIG. 1, each customer 102a-c has possession of and/or access to a menu 132 of the restaurant 130. The customers 102a-c generally look at the menu 132, decide which items are desired for purchase, and utilize one or more of the respective customer devices 104a-c and/or networks 108a-b (and/or network devices 108a-1, 108a-2, 108b-1) to contact the restaurant 130 to place an order. As the prior art system 100 generally requires that the customers 102a-c have previously gone to the restaurant 130 and/or otherwise previously acquired physical copies of the menu 132, other systems have been attempted that attempt to reduce these barriers to placing an order.

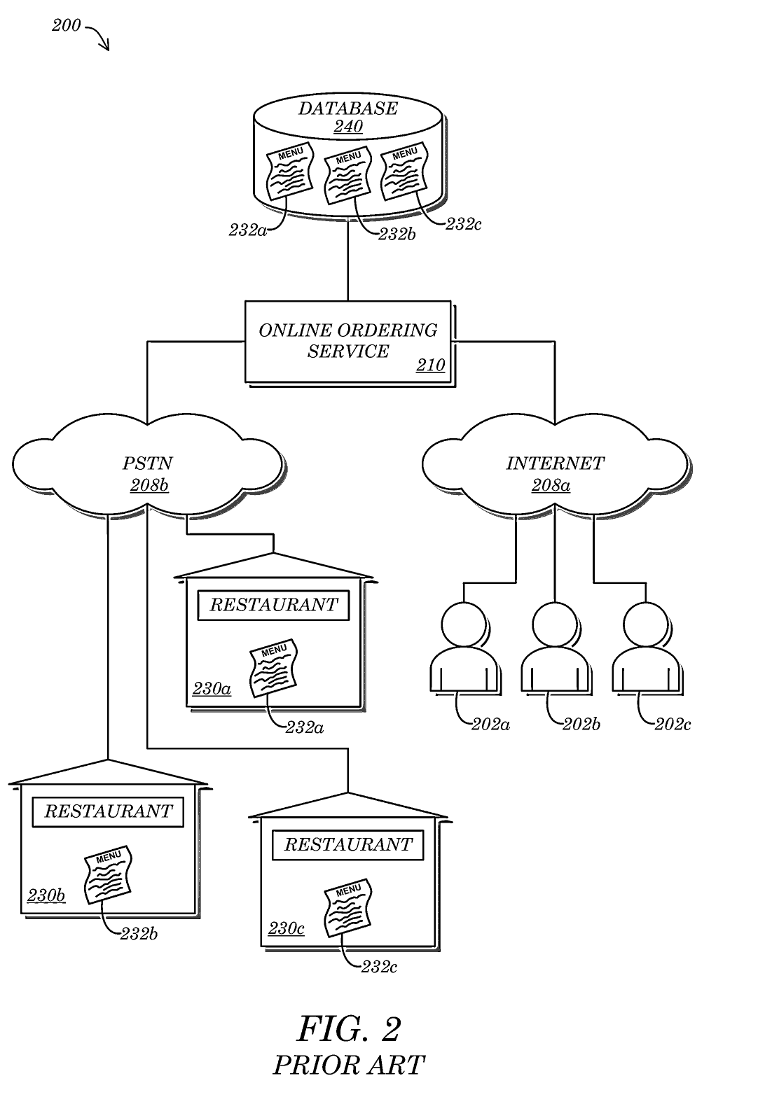

Turning to FIG. 2, for example, a block diagram of a prior art system 200 is shown. The prior art system 200 may, for example, represent and/or depict a currently available (e.g., itself not necessarily prior art) online ordering system/service such as the www.GrubHub.com web-service offered by GrubHub, Inc. of Chicago, Ill. The prior art system 200 may generally comprise a plurality of customers 202a-c that place orders via one or more networks 208a-b utilizing an online ordering service 210. The online ordering service 210 may, for example, receive orders and/or communications from the customers 202a-c via the Internet 208a and forward or transfer such orders via a PSTN 208b to one or more restaurants 230a-c. Such a prior art system 200 offers an advantage over the prior art system 100 of FIG. 1 in that menus 232a-c for the restaurants 230a-c are stored in a database 240 and provided to the customers 202a-c via the Internet 208a—e.g., eliminating the requirement that the customers 202a-c have previously acquired physical copies of the menus 232a-c.

Despite this advantage, attempts at implementing the prior art system 200 have met with limited, and mostly geographically-isolated, success. This is primarily due to the difficulty that the online ordering system 210 experienced in attracting and retaining the restaurants 230a-c to participate in the prior art system 200. Many small businesses, vendors, and/or retailers, for example, remain reluctant to join such services and/or aren't willing or able to dedicate the time and effort to upload, update, and/or manage online information (e.g., the menus 232a-c, as stored by the database 240). Many businesses that are willing to join such a service are frustrated by the fact that such services tend to serve limited geographic areas, with many areas not being covered by such a service. Accordingly, the prior art system 100 of FIG. 1 remains a typical avenue via which customers 102a-c, 202a-c place orders, such as for “take-out” dinner orders. Embodiments described herein provide systems, methods, and articles of manufacture that provide solutions to these and other mobile commerce problems.

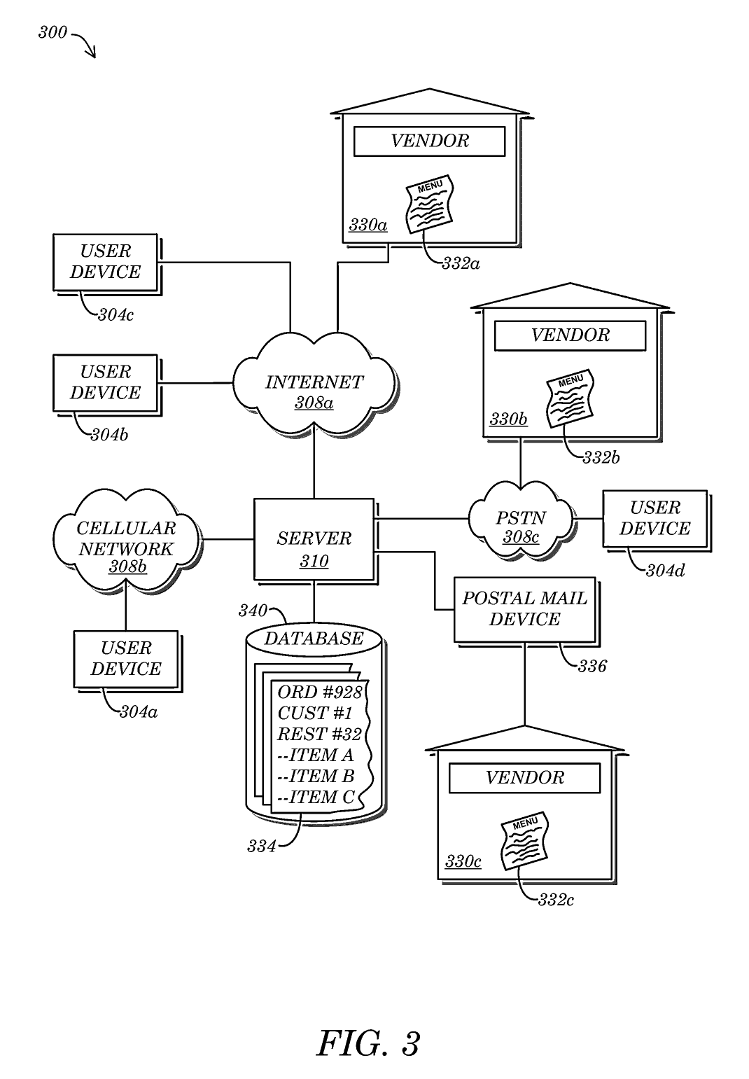

Referring now to FIG. 3, for example, a block diagram of a system 300 according to some embodiments is shown. In some embodiments, the system 300 may comprise an online ordering system such as a system that allows orders to be placed with merchants that lack an online presence and/or online menu or ordering capability. In some embodiments, the system 300 may comprise a plurality of user devices 304a-d in communication with and/or via one or more networks 308a-c (e.g., the Internet 308a, a cellular network 308b, and/or a PSTN 308c). In some embodiments, a server 310 may be in communication with the networks 308a-c and/or one or more of the user devices 304a-d. The user devices 320a-d may be utilized, for example, to place and/or send purchase requests for one or more vendors 330a-c, via the server 310. According to some embodiments, menus 332a-c of the vendors 330a-c, that may be available in physical form such as at the respective establishments of the vendors 330a-c, for example, may not be available to and/or via the user devices 304a-d and/or to and/or via the server 310. A first vendor 330a may comprise an “online” merchant, in some embodiments, while a second vendor 330b and/or a third vendor 330c may comprise “offline” merchants. The system 300 and/or the server 310 may, for example, allow, facilitate, and/or enable the user devices 304a-d to place online orders 334 with the “offline” vendors 330b-c and/or may allow, facilitate, and/or enable free-form and/or natural language orders 334 to be placed with the “online” vendor 330a, in accordance with embodiments described herein. According to some embodiments, the system 300 may comprise a postal mail device 336 (e.g., via which the server 310 may communicate with a third vendor 330c).

In some embodiments, the server 310 may be in communication with a database 340. The database 340 may store, for example, vendor data, communications data, data associated with customers and/or users (not explicitly shown) owning and/or operating the user devices 304a-d, data descriptive of orders 334, and/or instructions that cause various devices (e.g., the server 310 and/or the user devices 304a-d) to operate in accordance with embodiments described herein.

According to some embodiments, any or all of the components 304a-d, 308a-c, 310, 330a-c, 332a-c, 334, 336, 340 of the system 300 may be similar in configuration and/or functionality to any similarly named and/or numbered components described herein. Fewer or more components 304a-d, 308a-c, 310, 330a-c, 332a-c, 334, 336, 340 (and/or portions thereof) and/or various configurations of the components 304a-d, 308a-c, 310, 330a-c, 332a-c, 334, 336, 340 may be included in the system 300 without deviating from the scope of embodiments described herein. While multiple instances of some components 304a-d, 308a-c, 330a-c, 332a-c are depicted and while single instances of other components 310, 334, 336, 340 are depicted, for example, any component 304a-d, 308a-c, 310, 330a-c, 332a-c, 334, 336, 340 depicted in the system 300 may comprise a single device, a combination of devices and/or components 304a-d, 308a-c, 310, 330a-c, 332a-c, 334, 336, 340, and/or a plurality of devices, as is or becomes desirable and/or practicable. Similarly, in some embodiments, one or more of the various components 304a-d, 308a-c, 310, 330a-c, 332a-c, 334, 336, 340 may not be needed and/or desired in the system 300.

The user devices 304a-d, in some embodiments, may comprise any type or configuration of electronic, mobile electronic, and or other network and/or communication devices (or combinations thereof) that are or become known or practicable. A first user device 304a may, for example, comprise one or more PC devices, computer workstations (e.g., game consoles and/or kiosk computers), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the user devices 304a-d may be specifically utilized and/or configured (e.g., via specially-programmed and/or stored instructions such as may define or comprise a software application) to communicate with the server 310 (e.g., via the Internet 308a, the cellular network 308b, and/or the PSTN 308c).

The networks 308a-c may, according to some embodiments, generally comprise one or more LAN, WAN, cellular telephone networks, Bluetooth® networks, NFC networks, and/or RF networks with communication links between the user devices 304a-d, the server 310, the vendors 330a-c, and/or the database 340. In some embodiments, the networks 308a-c may comprise direct communications links between any or all of the components 304a-d, 310, 330, 336, 340 of the system 300. The server 310 may, for example, be directly interfaced or connected to the database 340 via one or more wires, cables, wireless links, and/or other network components, such network components (e.g., communication links) comprising portions of one or more of the networks 308a-c. In some embodiments, the networks 308a-c may comprise one or many other links or network components other than those depicted in FIG. 3. A second user device 304b may, for example, be connected to and/or in communication with the server 310 via various cell towers, routers, repeaters, ports, switches, and/or other network components that comprise the cellular network 308b. In some embodiments, a first user device 304a and/or a third user device 304c may be connected to and/or in communication with the server 310 via various towers, routers, repeaters, ports, switches, and/or other network components that comprise the Internet 308a. In some embodiments, a fourth user device 304d may be connected to and/or in communication with the server 310 via various towers, routers, repeaters, ports, switches, and/or other network components that comprise the PSTN 308c.

While the networks 308a-c are each depicted in FIG. 3 as a single objects, the networks 308a-c may comprise any number, type, and/or configuration of networks that are or becomes known or practicable. According to some embodiments, the networks 308a-c may comprise one or more conglomeration of different sub-networks and/or network components interconnected, directly or indirectly, by the components 304a-d, 310, 330, 336, 340 of the system 300.

According to some embodiments, the server 310 may comprise a device (and/or system) owned and/or operated by or on behalf of or for the benefit of an online ordering service entity (not explicitly shown). The online ordering service entity may utilize user, vendor, and/or order 334 information or instructions (e.g., stored by the database 340), in some embodiments, to host, manage, analyze, define, price, conduct, and/or otherwise provide (or cause to be provided) online ordering capabilities with respect to the vendors 330a-c. In some embodiments, the online ordering service entity (and/or a third-party; not explicitly shown) may provide an interface (not shown in FIG. 3) to and/or via the user devices 304a-d. The interface may be configured, according to some embodiments, to allow and/or facilitate online, free-form, and/or natural-language ordering capabilities with respect to the vendors 330a-c. According to some embodiments, the server 310 may provide, manage, cause, and/or facilitate social network “nudging” of one or more of the vendors 330a-c, such as the “offline” third vendor 330c, as described herein.

In some embodiments, the second vendor 330b and/or the third vendor 330c may comprise “offline” vendors. The “offline” vendors 330b-c may, for example, not accept orders 334 via the Internet 308a. In some embodiments, the first vendor 330a may comprise an “online” vendor that may have an online presence and/or ordering capability, but may generally require that orders 334 be submitted as selections from an online version of a first menu 332a. In such embodiments, the server 310 may provide free-form and/or natural-language ordering capabilities to enhance the basic online ordering capabilities already available to such “online” first vendor 330a.

According to some embodiments, the database 340 may comprise any type, configuration, and/or quantity of data storage devices that are or become known or practicable. The database 340 may, for example, comprise an array of optical and/or solid-state hard drives configured to store user, vendor, and/or order 334 data, and/or various operating instructions, drivers, etc. While the database 340 is depicted as a stand-alone component of the system 300 in FIG. 3, the database 340 may comprise multiple components. In some embodiments, a multi-component database 340 may be distributed across various devices and/or may comprise remotely dispersed components. Any or all of the user devices 304a-d may comprise the database 340 or a portion thereof, for example, and/or the server 310 may comprise the database 340 or a portion thereof.

In some embodiments, the system 300 may be utilized to (i) allow, enable, and/or facilitate online ordering for “offline” vendors 330b-c, (ii) allow, enable, and/or facilitate free-form and/or natural language ordering for the “online” vendor 330a and/or the “offline” vendors 330b-c, (iii) allow, enable, and/or facilitate social media “nudging” of the “offline” vendors 330b-c, (iv) allow, enable, and/or facilitate geo-location based ordering functionality for the user devices 304a-d, and/or (v) allow, enable, and/or facilitate automatic online menu building (and/or updating) for the “online” vendor 330a and/or the “offline” vendors 330b-c.

As an example, the first user device 304a may be utilized to submit a purchase request, to the server 310 (e.g., via the Internet 308a) for a desired item from the “offline” second vendor 330b. This may be conducted in the absence of access to the second menu 332b (e.g., a user of the first user device 304a may not have picked up a copy of the second menu 332b from the second vendor 330b, and the second vendor 330b may comprise an “offline” merchant not having and online presence and/or ordering capability enabled)—e.g., a “menuless” purchase request. As the menu items from the second menu 332b are not explicitly known, the purchase request from the first user device 304a may generally comprise a free-form and/or natural language description of the desired item. The server 310 may, in some embodiments, process the free-form and/or natural-language request to determine a description of the desired item. The description may, for example, comprise a standardized, scrubbed and/or cleaned, de-duplicated, spelling and/or syntax corrected version of the original text from the request. In some embodiments, the server 310 may transmit an indication of the product description to the second vendor 330b (e.g., via the PSTN 308c). In some embodiments, the second vendor 330b may respond to the server 310 with an indication of whether the product description matches any product description from the second menu 332b. The second vendor 330b may respond that the description matches and/or is otherwise understood or recognized and the order is being processed, for example, or may respond that no such product is available, or may respond with an alternate/similar description representing a product from the second menu 332b (e.g., and/or request confirmation that the updated/corrected/alternate description is acceptable).

In another example, the second user device 304b may be utilized to submit a purchase request, to the server 310 (e.g., via the cellular network 308b) for a desired item from the “online” first vendor 330a. This may also or alternatively comprise a “menuless” purchase request, or may be conducted with access to the first menu 332a. In either case, the purchase request may, for convenience for example, be permitted to comprise a free-form and/or natural language description of the desired item (e.g., as opposed to a selection of an item from an online version of the first menu 332a and/or an interface associated therewith). The second user device 304b may comprise a cellular telephone, for example, and the purchase request may comprise a text message (e.g., in accordance with the Short Message Service (SMS) protocol as defined by the Global Systems for Mobile Communications (GSM) Document 28/85 “Services and Facilities to be provided in the GSM System” rev2, June 1985). In such a manner, for example, the customer utilizing the second customer device 304b may quickly and easily submit a text-message purchase request, without having to visit the website and/or without having to interface with a particular application associated with the online availability of the first menu 332a.

The server 310 may, in some embodiments, process the free-form and/or natural-language request to determine a description of the desired item. The description may, for example, comprise a standardized, scrubbed and/or cleaned, de-duplicated, spelling and/or syntax corrected version of the original text from the request. In some embodiments, the server 310 may compare the product description to the first menu 332a to determine which item(s) from the first menu 332a matches the request. In the case that a match is found, an order 334 may be created and sent to the first vendor 330a. In some embodiments, the server 310 may prompt (or cause a prompting of) the customer via the second customer device 304b and request more information, clarification of information from the request, and/or may ask for a selection of one or more of the closest matches the server 310 was able to find. In some embodiments (such as in the case that a match cannot be found), the server 310 may transmit an indication of the product description to the first vendor 330a (e.g., via the Internet 308a). In some embodiments, the first vendor 330a may respond to the server 310 with an indication of whether the product description matches any product description from the first menu 332a. The first vendor 330a may respond that the description matches and/or is otherwise understood or recognized and the order is being processed, for example, or may respond that no such product is available, or may respond with an alternate/similar description representing a product from the first menu 332a (e.g., and/or request confirmation that the updated/corrected/alternate description is acceptable).

In yet another example, the plurality of customers operating the customer devices 304a-d may desire to conduct online purchases from the “offline” third vendor 330c. As depicted in FIG. 3, however, the third vendor 330c is indeed “offline” and thus offers no such service and ordering service via the server 310 may also not be available (e.g., the third vendor 330c may not even allow or permit fax or voice calls from the server 310 to place orders 334 on behalf of others). The server 310 may allow, enable, and/or facilitate, however, the customers (e.g., via the customer devices 304a-d ) to express their desire to have online ordering functionality become available for the third vendor 330c. the server 310 may, for example, comprise and/or utilize a social networking site such as Facebook® that allows the customers to, for example, click on a “Like” or “Nudge” button to indicate their desire for online ordering functionality. The server 310 may tabulate, aggregate, and/or otherwise report on the number of customers (and/or other associated metrics) desiring such functionality. In some embodiments, the server 310 may utilize the postal mail device 336 to send an indication of the demand for online ordering functionality to the third vendor 330c. In some embodiments, the indication of demand (or “nudge”) may be accompanied with materials detailing how the third vendor 330c may participate in the system 300. In such a manner, for example, a non-participating entity such as the third vendor 330c may be convinced to join the system 300 based on the level of demand recorded by the server 310 (e.g., in the database 340).

In still another example, the fourth user device 304d may be utilized to submit a natural-language purchase request to the server 310 (e.g., via the PSTN 308c). In some embodiments, the request may not identify a particular vendor 330a-c, but instead may comprise geo-location information along with the natural-language text. The server 310 may, in accordance with some embodiments, compare the request text to data stored in the database 340 such as an order history for the customer operating the fourth customer device 304d (and/or a history for the fourth customer device 304d, irrespective of who was utilizing it; not explicitly shown in FIG. 3) and/or previously completed (e.g., successful) orders 334. Data descriptive of the orders 334 from the requests completed by the first and second user devices 304a-b as described in the examples above, for example, may be stored in the database 340 and/or utilized to build and/or update an online menu (visible to customers or not) for various merchants 330a-c. The incoming text from the fourth user device 304d may be compared to any or all of this data to determine if a match exits (e.g., a text parsing and/or comparison match within some pre-determined confidence level threshold). In the case that the incoming text matches the description for “Item A” for “Rest #32” (e.g., restaurant number thirty-two (32)), for example, efficiency may be realized in assuming that because a previous customer consummated a purchase for such an item at such a restaurant, the present customer is likely to be able to do so as well. This type of assumption/analysis by the server 310 may reduce the amount of back-and-forth likely and/or required with individual vendors 330a-c in determining whether incoming natural-language descriptions match items actually offered for sale by the vendors 330a-c. According to some embodiments, the server 310 may utilize the geo-location information to select and/or identify a vendor 330a-c to which to send an order 334 based on the purchase request. Such a selection may comprise providing a menu or listing of available/proximate vendors 330a-c from which the customer may select a desired vendor 330a-c, automatically selecting a vendor 330a-c based on, e.g., proximity to the fourth customer device 304d and/or a determination that the desired item(s) are sold by a particular vendor 330a-c, and/or identifying and/or selecting a vendor 330a-c based on predefined preferences and/or “favorites” of the customer (or of other customers—e.g., ratings and/or reviews).

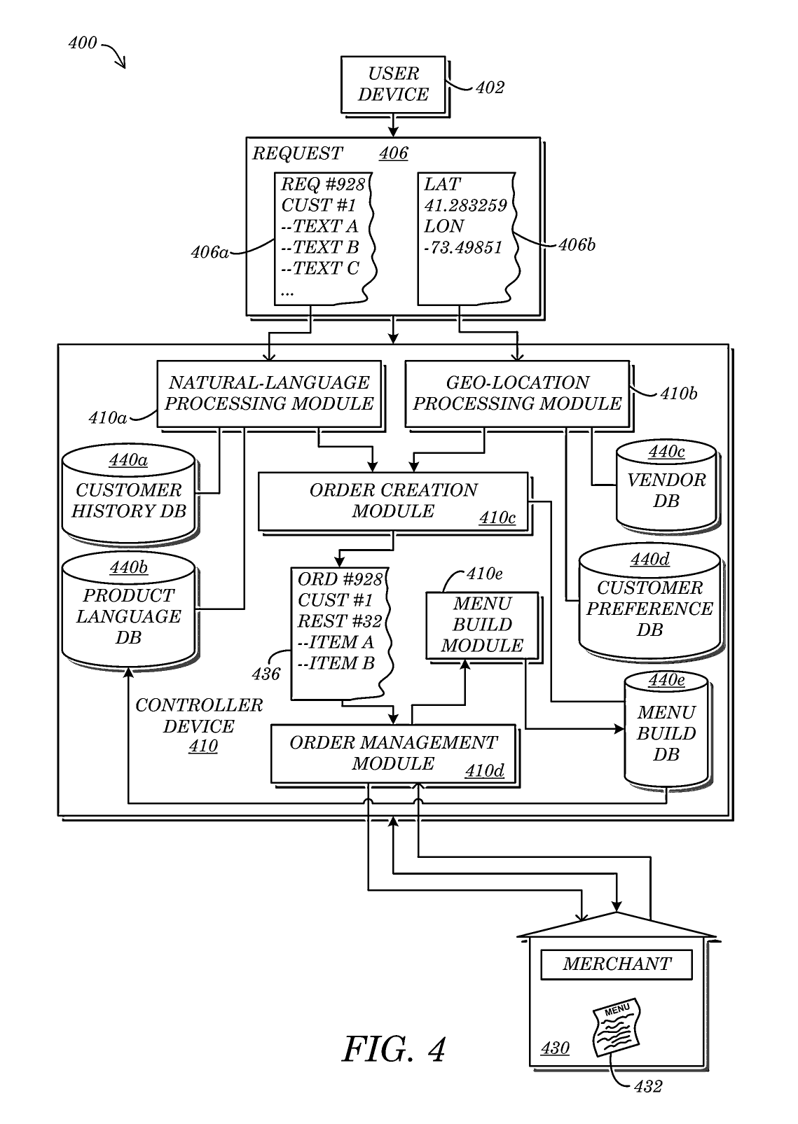

Referring now to FIG. 4, a block diagram of a system 400 according to some embodiments is shown. In some embodiments, the system 400 may comprise an online ordering platform that permits free-form and/or natural language ordering of items from various “online” and/or “offline” merchants. In some embodiments, the system 400 may comprise a user device 404 that is utilized to submit a request 406 (e.g., comprising a natural-language text portion 406a and/or a geo-location data portion 406b) to a controller device 410. The controller device 410 may comprise a natural-language processing module 410a, a geo-location processing module 410b, an order creation module 410c, an order management module 410d, and/or a menu build module 410e. In some embodiments, the controller device 410 may communicate with a merchant 430 (e.g., having a menu 432), such as to provide an order 436. In some embodiments, the controller device 410 and/or one or more of the modules 410a-e thereof may have access to and/or comprise one or more databases 440a-e. The databases 440a-e may comprise, for example, a customer history database 440a, a product language database 440b, a vendor database 440c, a customer preference database 440d, and/or a menu build database 440e.

According to some embodiments, any or all of the components 404, 406a-b, 410a-e, 430, 440a-e of the system 400 may be similar in configuration and/or functionality to any similarly named and/or numbered components described herein. Fewer or more components 404, 406a-b, 410a-e, 430, 440a-e (and/or portions thereof) and/or various configurations of the components 404, 406a-b, 410a-e, 430, 440a-e may be included in the system 400 without deviating from the scope of embodiments described herein. While multiple instances of some components 406a-b, 410a-e, 440a-e are depicted and while single instances of other components 404, 430 are depicted, for example, any component 404, 406a-b, 410a-e, 430, 440a-e depicted in the system 400 may comprise a single device, a combination of devices and/or components 404, 406a-b, 410a-e, 430, 440a-e, and/or a plurality of devices, as is or becomes desirable and/or practicable. Similarly, in some embodiments, one or more of the various components 404, 406a-b, 410a-e, 430, 440a-e may not be needed and/or desired in the system 400.

According to some embodiments, the user device 404 may be utilized to generate, define, and/or otherwise determine the request 406. A user (not shown in FIG. 4) may, for example, input information into the user device 404, make menu and/or application selections utilizing the user device 404, and/or may otherwise define and/or select or identify the request 406 (and/or portions thereof). In some embodiments, the request 406 may comprise the natural-language text portion 406a, including for example, a request identifier “Req #928”, a customer identifier “Oust #1”, and/or various text elements “Text A”, “Text B”, and/or “Text C”. The natural-language text portion 406a may, in some embodiments, be provided via a text-message (e.g., SMS), e-mail, voice-recognition and/or textual conversion (e.g., speech-to-text) technology, etc.

In some embodiments, the natural-language text portion 406a may be received by the natural-language processing module 410a of the controller device 410. The natural-language processing module 410a may, according to some embodiments, parse, deconstruct, analyze, decode, score, rank, and/or otherwise process the natural-language text portion 406a. In some embodiments, the natural-language processing module 410a may generate, define, calculate, and/or otherwise determine, from the natural-language text portion 406a, one or more product descriptions. In the case that the “Text A” segment of the natural-language text portion 406a reads “large pizza with pepperoni and a coke”, for example, the natural-language processing module 410a may interpret the request 406 to be: “1 large pepperoni pizza, and 1 coke”. In some embodiments, the natural-language processing module 410a may be configured to recognize and/or interpret pre-defined and/or on-the-fly shortcuts and/or shorthand such as where “pz” equals “pizza” and/or “ham” equals hamburger. In some embodiments, the natural-language processing module 410a may access and/or utilize data from the customer history database 440a and/or the product language database 440b to interpret and/or analyze the natural-language text portion 406a.

The natural-language processing module 410a may, for example, compare the natural-language text portion 406a (or a portion thereof, such as the “Text A” segment) to data descriptive of previous requests (e.g., identified by the “Oust #1” and/or an identifier of the user device 404, such as a Media Access Control (MAC) and/or Ethernet Hardware Address (EHA) identifier or network identifier such as an Internet Protocol (IP) address) submitted by the user and/or user device 404. In the case that there is some historic frequency of the user and/or user device 404 submitting requests that were ultimately determined to equate the term “pza” with “pizza”, for example, the current request 406 and/or the natural-language text portion 406a (or a portion thereof, such as in the case that the “Text B” segment comprises the text “3 lrg pza w chz”) may be matched to such previous data to quickly determine the meaning of the incoming request 406. In some embodiments, the natural-language processing module 410a may compare the natural-language text portion 406a to data stored in the product language database 440b. In the case that the user and/or user device 404 is not associated with a previous request for example, the natural-language text portion 406a may be compared to stored text strings and/or codes to determine one or more likely product descriptions based on the request 406. In some embodiments, the data stored in the product language database 440b may be based on and/or updated utilizing information from orders 436, information from menus (such as the menu 432), and/or information third-party sources (not shown in FIG. 4) such as linguistic, dictionary, thesaurus, and/or other text analysis-related sources. In some embodiments, the natural-language processing module 410a may provide text analysis results such as one or more product descriptions to the order creation module 410c.

According to some embodiments, the geo-location data portion 406b may be received by the geo-location module 410b of the controller device 410. The geo-location module 410b may, for example, analyze the geo-location data portion 406b to determine one or more coordinates, locations, street addresses, postal codes and/or other regional identifiers, telephone area codes, businesses names, customer names, etc. In some embodiments, the geo-location module 410b may utilize information stored in the vendor database 440c and/or the customer preference database 440d to determine location and/or location-related information. In the case that the request 406 comprises an indication that the customer desires the system 400 and/or the controller device 410 to select one or more merchants 430 to fulfill the request 406, for example, the geo-location module 410b may utilize the received geo-location data portion 406b and data stored in the vendor database 440c, such as vendor location information, to determine a listing of merchants in proximity to the location specified by the geo-location data portion 406b. In the case that the user and/or user device 404 is determined to be located near a particular intersection of roads in a town, for example, the vendor database 440c may be utilized to determine which merchants are within a particular radius from the location (e.g., one hundred yards (100-yds), one half mile (½ mi), and/or within a five-minute (5-min) drive or walk).

According to some embodiments, the geo-location data portion 406b may be compared to user preference data stored in the customer preference database 440d. The user of the user device 404 may have previously indicated, for example, that when the user and/or user device 404 is located in a certain area, region, and/or location, that the user prefers for the merchant 430 (e.g., a particular vendor and/or vendors) to be utilized to fulfill requests 406 and/or requests 406 of a particular type. In such a manner, for example, a user may define (and the system 400 may store and utilize) “geo-based favorites” or “geo-favorites”. This feature may be applicable to non-purchase requests 406 as well, such as web and/or other searches. Favorites of a user may be altered based on where the user is located, for example, such as allowing the user to specify that when in area “A” a ‘favorite’ website/restaurant/etc. comprises a first website/restaurant/etc., but when in area “B” a ‘favorite’ website/restaurant/etc. comprises a second website/restaurant/etc. In some embodiments, the geo-location module 410b may provide geo-location analysis results such as one or more merchant identifiers to the order creation module 410c.

In some embodiments, the order creation module 410c may receive one or more of (i) text analysis results such as one or more product descriptions from the natural-language processing module 410a, and/or (ii) one or more merchant identifiers from the geo-location module 410b. The order creation module 410c may, in accordance with some embodiments, utilize the received information descriptive of the request 406 to create, generate, define, identify, and/or otherwise determine the order 436. The order 436 may generally comprise an indication of the merchant 430 and an indication of one or more products requested for purchase from the merchant 430 (e.g., “Item A” and/or “Item B”). In some embodiments, the order 436 may be provided to the order management module 410d which may then, for example, transmit an indication of the order 436 to the merchant 430. In some embodiments, such as in the case that the order creation module 410c lacks enough information to construct the order 436 and/or determines that some information is ambiguous (e.g., could identify multiple products, product sizes, variants, etc.), the order creation module 410c and/or the order management module 410d may transmit a request for more information and/or clarification to the user device 404 (such communication not explicitly shown in FIG. 4).

According to some embodiments, the merchant 430 may send a response to the order 436 back to the controller device 410 and/or the order management module 410d. The merchant 430 may indicate, for example, that the order 436 (and/or a portion thereof) is accepted and/or fulfilled, that the order 436 (and/or a portion thereof) is not accepted and/or not yet fulfilled (and/or provide an estimated fulfillment time, pickup identifier, queue number, etc.), and/or may request and/or indicate that clarification is needed. In the case that the order 436 comprises an indication of “Item A” which comprises the product description “20 oz. pepsi”, for example, the merchant 430 may respond with an indication of a similar (e.g., best match from the menu 432) product description such as “20 oz. coke” and/or may provide a question or query such as: “we don't carry 20 oz. sizes, but we do have a 16 oz. size, would that be okay?” According to some embodiments, rules may be established that permit the merchant 430 to automatically substitute products, products of certain types, and/or products having similar classifications and similar prices (e.g., within a pre-determined threshold). According to some embodiments, the order management module 410d may process and/or respond to return queries from the merchant 430. According to some embodiments, such as in the case that user input and/or clarification is deemed necessary, the order management module 410d and/or the controller device 410 may transmit a request for clarification and/or acceptance of an alternate product to the user device 404 (such communication not explicitly shown in FIG. 4).

In some embodiments, particularly in the case that the merchant 430 comprises an “offline” merchant, the cost of the order 436 may not be known at the time of transmission to the merchant 430. In such embodiments, a response from the merchant 430 may comprise an indication of an order amount which may (e.g., unless predefined rules permit automatic payment acceptance for order values of a certain magnitude and/or range) be transmitted to the user device 404 for verification.

According to some embodiments, feedback information from the merchant 430 such as whether a product description of the order 436 matches an item on the menu 432, product pricing information, and/or other product and/or ordering details may be provided to the menu build module 410e. The menu build module 410e may, for example, utilize such information to populate and/or update the menu build database 440e. The menu build module 410e may, in some embodiments, effectively “build”, construct, and/or define an online menu from information descriptive of orders 436 approved and/or consummated by the merchant 430. Over time, a substantially complete online menu for an “offline” vendor may be constructed with only transactional involvement from the merchant 430. In some embodiments, such an online menu may be provided to the user device 404 to facilitate menu-driven ordering if desired, or simply may be utilized to populate and/or update the product language database 440b and/or inform the processing of the order creation module 410c. In some embodiments, the stored pricing information from past transactions may be utilized to estimate or predict order values. Such estimated values may be provided, in some embodiments, to the user device 404 in response to the request 406.

While the example depicted in the system 400 of FIG. 4 shows the request 406 comprising both a natural-language portion 406a and a geo-location data portion 406b, fewer or more portions may be included in the request 406 as is or becomes practicable and/or desirable. The geo-location data portion 406b may not be required in the case that the request 406 otherwise identifies a desired merchant 430, for example.

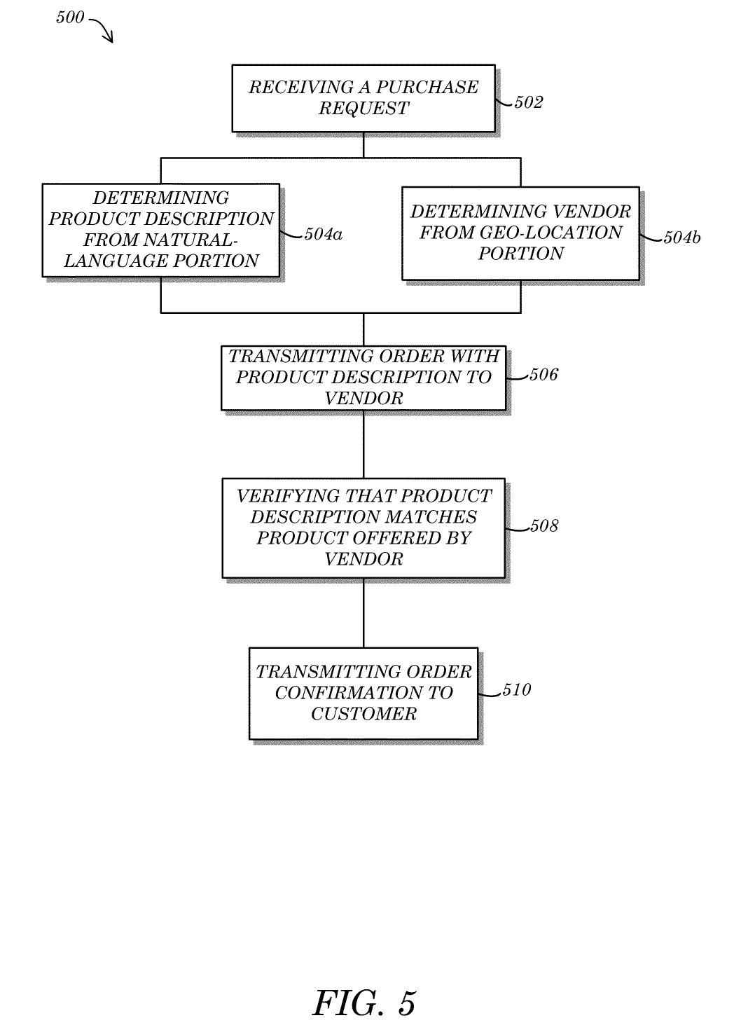

Turning to FIG. 5, a flow diagram of a method 500 according to some embodiments is shown. In some embodiments, the method 500 may be performed and/or implemented by and/or otherwise associated with one or more specialized and/or computerized processing devices (e.g., the user devices 304a-d, 404 and/or the servers and/or controller devices 310, 410a-e of FIG. 3 and/or FIG. 4 herein), specialized computers, computer terminals, computer servers, computer systems and/or networks, and/or any combinations thereof (e.g., by one or more online gaming company and/or online gaming player processing devices). In some embodiments, the method 500 may be embodied in, facilitated by, and/or otherwise associated with various input mechanisms and/or interfaces provided by devices as described herein.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 500 may comprise receiving a purchase request, at 502. Data from a user and/or user device may, for example, be descriptive of one or more parameters associated with a purchase that a user and/or customer desires to conduct. In some embodiments, the request may comprise an identifier of the customer, an account identifier, an identifier of a desired and/or preferred vendor, geo-location information, and/or desired product information. In some embodiments, the desired product information may comprise free-form and/or natural-language data—e.g., as opposed to menu selections made via a website and/or mobile application.

According to some embodiments, the method 500 may comprise determining a product description from a natural-language portion of the request, at 504a. Free-form and/or natural-language text received from a user device (and received by a server device) may, for example, be analyzed utilizing a set of stored rules and/or algorithms to determine and/or identify one or more product description therefrom. Textual analysis rules may be utilized, in some embodiments, to parse out product descriptions from the received text and/or to match portions of the received text to likely product descriptions.

In some embodiments, the method 500 may comprise determining a vendor from a geo-location portion of the request, at 504b. One or more vendors to fulfill the request (such as in the case that the request does not identify a vendor) may be selected from a plurality of available and/or known vendors, for example, by comparing customer geo-location data to vendor geo-location data. Vendors within a certain and/or selected proximity or range (distance or travel time) from the customer, a device associated with the customer, and/or from a future location of the customer (e.g., a route destination and/or waypoint), for example, may be selected from the pool of known vendors. In some embodiments, the geo-location data may define one or more customer preferences and/or favorites (such as “geo-favorites”) that inform and/or define the vendor selection process.

According to some embodiments, the method 500 may comprise transmitting an order with the product description to the vendor, at 506. The vendor identified at 504b, for example, may be provided with a request for the purchase of any products deemed to be desired as a result of the analysis at 504a.

In some embodiments, the method 500 may comprise verifying that the product description matches a product offered by the vendor, at 508. In some embodiments, the verifying may be conducted prior to the transmitting at 506, such as in the case that the vendor comprises an “online” vendor and/or the system otherwise has access to product descriptions from a menu of the vendor. In some embodiments, the verifying may be conducted after the transmitting at 506, such as in the case that the vendor comprises an “offline” vendor. In some embodiments, the verifying may comprise receiving a confirmation and/or other data from the vendor in response to the transmitting at 506. The vendor may respond, for example, be providing product pricing information, updated and/or corrected product description information, and/or by suggesting an alternate, similar, and/or closest matched-product requiring verification from the customer regarding desire to purchase (e.g., unless the vendor and/or system has authority to automatically substitute and/or select similar products based on the initial request).

According to some embodiments, the method 500 may comprise transmitting an order confirmation to the customer, at 510. In the case that the order has been verified to match a menu item, for example, or in the case that the vendor otherwise accepts the order, the customer may be notified. In some embodiments, such as in the case that the vendor comprises an “offline” vendor, the confirmation may comprise an indication of an order price. In the case that the confirmation comprises the first time that the customer is made aware of the price, the customer may be given an opportunity to amend, retract, and/or cancel the order prior to being charged. According to some embodiments, the customer may be given the opportunity to verify the natural-language processing at 504a (e.g., before or after the transmitting at 506).

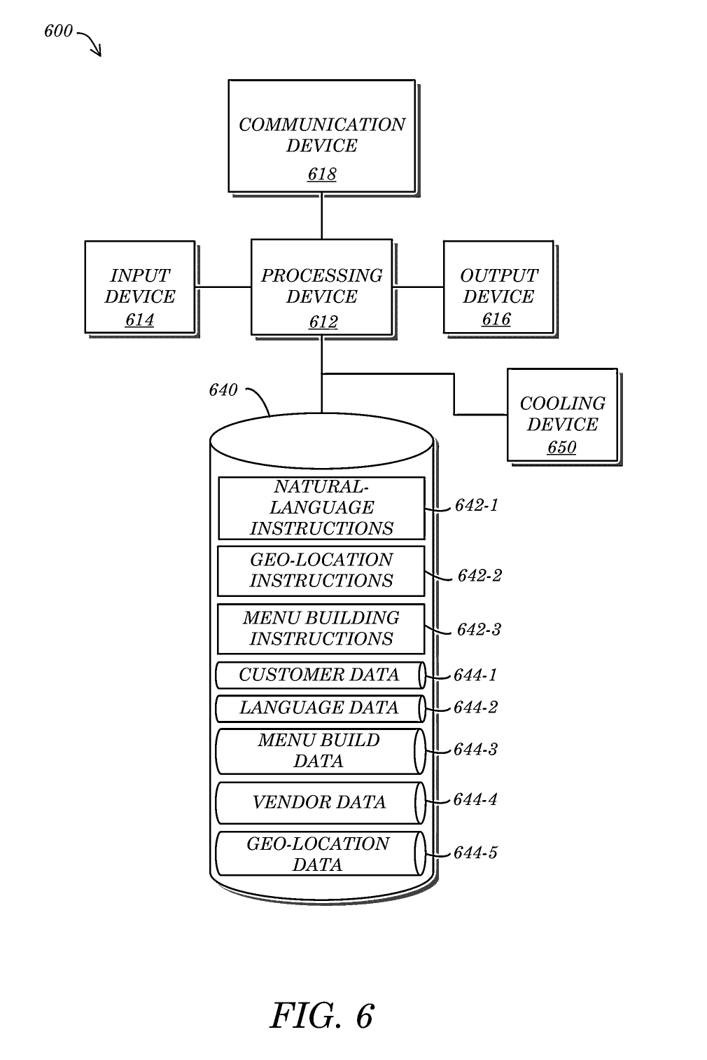

Turning to FIG. 6, a block diagram of an apparatus 600 according to some embodiments is shown. In some embodiments, the apparatus 600 may be similar in configuration and/or functionality to any of the user devices 304a-d, 404 and/or the servers and/or controller devices 310, 410a-e of FIG. 3 and/or FIG. 4 herein, and/or may otherwise comprise a portion of the systems 100, 200, 300, 400 of FIG. 1, FIG. 2, FIG. 3, and/or FIG. 4 herein. The apparatus 600 may, for example, execute, process, facilitate, and/or otherwise be associated with the method 500 described in conjunction with FIG. 5 herein. In some embodiments, the apparatus 600 may comprise a processing device 612, an input device 614, an output device 616, a communication device 618, a memory device 640, and/or a cooling device 650. According to some embodiments, any or all of the components 612, 614, 616, 618, 640, 650 of the apparatus 600 may be similar in configuration and/or functionality to any similarly named and/or numbered components described herein. Fewer or more components 612, 614, 616, 618, 640, 650 and/or various configurations of the components 612, 614, 616, 618, 640, 650 be included in the apparatus 600 without deviating from the scope of embodiments described herein.

According to some embodiments, the processing device 612 may be or include any type, quantity, and/or configuration of electronic and/or computerized processor that is or becomes known. The processing device 612 may comprise, for example, an Intel® IXP 2800 network processor or an Intel® XEON™ Processor coupled with an Intel® E7501 chipset. In some embodiments, the processing device 612 may comprise multiple inter-connected processors, microprocessors, and/or micro-engines. According to some embodiments, the processing device 612 (and/or the apparatus 600 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 600 comprises a server such as a blade server, necessary power may be supplied via a standard AC outlet, power strip, surge protector, a Power Distribution Unit (PDU), and/or Uninterruptible Power Supply (UPS) device.

In some embodiments, the input device 614 and/or the output device 616 are communicatively coupled to the processing device 612 (e.g., via wired and/or wireless connections and/or pathways) and they may generally comprise any types or configurations of input and output components and/or devices that are or become known, respectively. The input device 614 may comprise, for example, a keyboard that allows an operator of the apparatus 600 to interface with the apparatus 600 (e.g., by a user, such as to place online orders for “offline” vendors and/or to place free-form and/or natural-language orders as described herein). In some embodiments, the input device 614 may comprise a sensor configured to provide information such as geo-location information to the apparatus 600 and/or the processing device 612. The output device 616 may, according to some embodiments, comprise a display screen and/or other practicable output component and/or device. The output device 616 may, for example, provide a free-form and/or natural-language purchase interface (not explicitly shown in FIG. 6) to a user (e.g., via a website). According to some embodiments, the input device 614 and/or the output device 616 may comprise and/or be embodied in a single device such as a touch-screen monitor.

In some embodiments, the communication device 618 may comprise any type or configuration of communication device that is or becomes known or practicable. The communication device 618 may, for example, comprise a Network Interface Card (NIC), a telephonic device, a cellular network device, a router, a hub, a modem, and/or a communications port or cable. In some embodiments, the communication device 618 may be coupled to receive data from a user device (not shown in FIG. 6), such as in the case that the apparatus 600 is utilized to accept and/or process free-form and/or natural-language purchase requests as described herein. The communication device 618 may, for example, comprise a cellular telephone network transmission device that sends signals indicative of free-form and/or natural-language purchase requests from a customer and/or user handheld, mobile, and/or telephone device. According to some embodiments, the communication device 618 may also or alternatively be coupled to the processing device 612. In some embodiments, the communication device 618 may comprise an IR, RF, NFC, Bluetooth™, and/or Wi-Fi® network device coupled to facilitate communications between the processing device 612 and another device (such as a user device and/or a third-party device).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of natural-language instructions 642-1, geo-location instructions 642-2, and/or menu building instructions 642-3. In some embodiments, the natural-language instructions 642-1, geo-location instructions 642-2, and/or menu building instructions 642-3 may be utilized by the processing device 612 to provide output information via the output device 616 and/or the communication device 618.

According to some embodiments, the natural-language instructions 642-1 may be operable to cause the processing device 612 to process customer data 644-1, language data 644-2, menu build data 644-3, vendor data 644-4, and/or geo-location data 644-4. Customer data 644-1, language data 644-2, menu build data 644-3, vendor data 644-4, and/or geo-location data 644-4 received via the input device 614 and/or the communication device 618 may, for example, be analyzed, sorted, filtered, decoded, decompressed, ranked, scored, plotted, and/or otherwise processed by the processing device 612 in accordance with the natural-language instructions 642-1. In some embodiments, customer data 644-1, language data 644-2, menu build data 644-3, vendor data 644-4, and/or geo-location data 644-4 may be fed by the processing device 612 through one or more mathematical and/or statistical formulas and/or models in accordance with the natural-language instructions 642-1 to interpret, decode, decipher, and/or analyze free-form and/or natural-language purchase requests, in accordance with embodiments described herein.

In some embodiments, the geo-location instructions 642-2 may be operable to cause the processing device 612 to process customer data 644-1, language data 644-2, menu build data 644-3, vendor data 644-4, and/or geo-location data 644-4. Customer data 644-1, language data 644-2, menu build data 644-3, vendor data 644-4, and/or geo-location data 644-4 received via the input device 614 and/or the communication device 618 may, for example, be analyzed, sorted, filtered, decoded, decompressed, ranked, scored, plotted, and/or otherwise processed by the processing device 612 in accordance with the geo-location instructions 642-2. In some embodiments, customer data 644-1, language data 644-2, menu build data 644-3, vendor data 644-4, and/or geo-location data 644-4 may be fed by the processing device 612 through one or more mathematical and/or statistical formulas and/or models in accordance with the geo-location instructions 642-2 to determine or select vendors to fulfill purchase requests from proximate customers, in accordance with embodiments described herein.

According to embodiments, the menu building instructions 642-3 may be operable to cause the processing device 612 to process customer data 644-1, language data 644-2, menu build data 644-3, vendor data 644-4, and/or geo-location data 644-4. Customer data 644-1, language data 644-2, menu build data 644-3, vendor data 644-4, and/or geo-location data 644-4 received via the input device 614 and/or the communication device 618 may, for example, be analyzed, sorted, filtered, decoded, decompressed, ranked, scored, plotted, and/or otherwise processed by the processing device 612 in accordance with the menu building instructions 642-3. In some embodiments, customer data 644-1, language data 644-2, menu build data 644-3, vendor data 644-4, and/or geo-location data 644-4 may be fed by the processing device 612 through one or more mathematical and/or statistical formulas and/or models in accordance with the menu building instructions 642-3 to construct and/or update online menu data on behalf of an “offline” vendor, in accordance with embodiments described herein

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 600. According to some embodiments, the memory device 640 may be incorporated into and/or otherwise coupled to the apparatus 600 (e.g., as shown) or may simply be accessible to the apparatus 600 (e.g., externally located and/or situated).

In some embodiments, the apparatus 600 may comprise a cooling device 650. According to some embodiments, the cooling device 650 may be coupled (physically, thermally, and/or electrically) to the processing device 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 600.

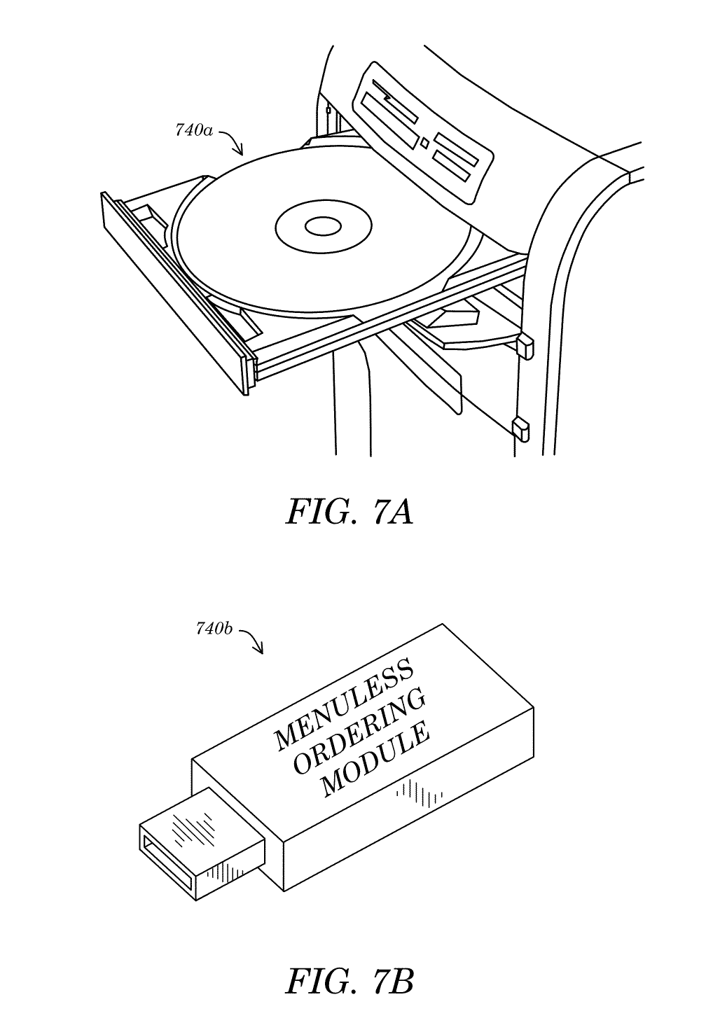

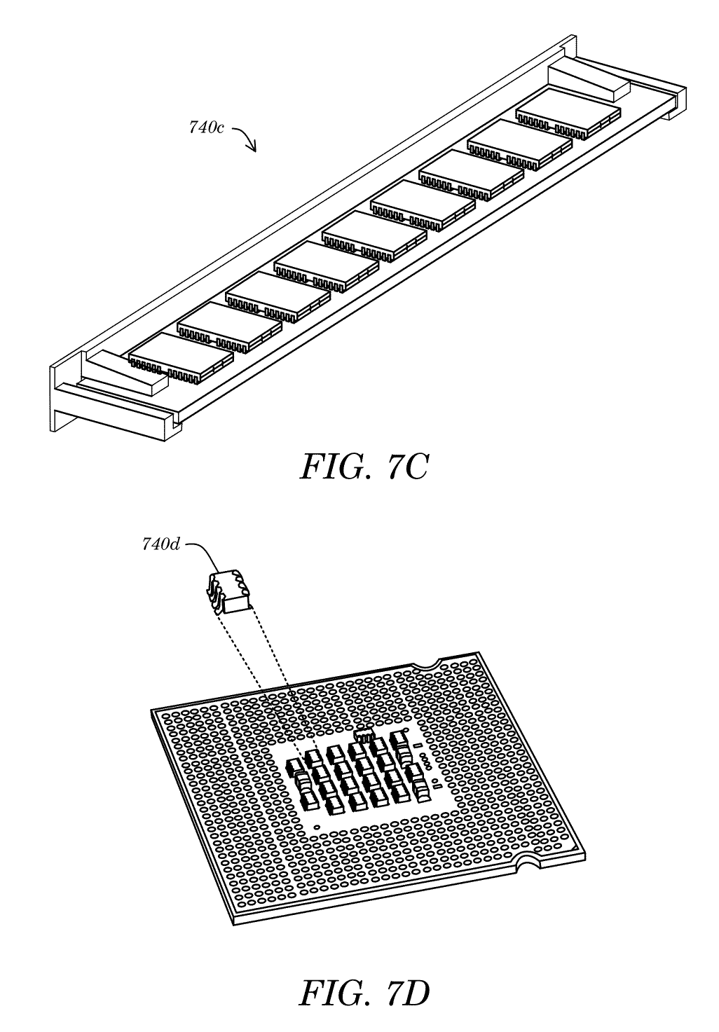

Referring now to FIG. 7A, FIG. 7B, FIG. 7C, and FIG. 7D, perspective diagrams of exemplary data storage devices 740a-d according to some embodiments are shown. The data storage devices 740a-d may, for example, be utilized to store instructions and/or data such as the customer data 644-1, language data 644-2, menu build data 644-3, vendor data 644-4, and/or geo-location data 644-4, each of which is described in reference to FIG. 6 herein. In some embodiments, instructions stored on the data storage devices 740a-d may, when executed by a processor (such as the processor device 612 of FIG. 6), cause the implementation of and/or facilitate the method 500 described in conjunction with FIG. 5, and/or portions thereof, as described herein.

According to some embodiments, the first data storage device 740a may comprise a CD, CD-ROM, DVD, Blu-Ray™ Disc, and/or other type of optically-encoded disk and/or other computer-readable storage medium that is or becomes know or practicable. In some embodiments, the second data storage device 740b may comprise a USB keyfob, dongle, and/or other type of flash memory data storage device that is or becomes know or practicable. According to some embodiments, the third data storage device 740c may comprise RAM of any type, quantity, and/or configuration that is or becomes practicable and/or desirable. In some embodiments, the third data storage device 740c may comprise an off-chip cache such as a Level 2 (L2) or Level 3 (L3) cache memory device. According to some embodiments, the fourth data storage device 740d may comprise an on-chip memory device such as a Level 1 (L1) cache memory device.

The data storage devices 740a-d may generally store program instructions, code, and/or modules that, when executed by an electronic and/or computerized processing device cause a particular machine to function in accordance with embodiments described herein. In some embodiments, the data storage devices 740a-d depicted in FIG. 7A, FIG. 7B, FIG. 7C, and FIG. 7D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may generally refer to any device that can communicate via a network. Examples of user and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

As used herein, the term “network component” may refer to a player or network device, or a component, piece, portion, or combination of player or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an gaming entity may, for example, comprise various specialized computers that interact to provide for online games as described herein

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by a processing device and from a device operated by a customer, a request for a purchase, wherein the request comprises a natural-language text portion descriptive of one or more desired products for the purchase;
determining, by the processing device and based on the natural-language text portion of the purchase request, one or more product descriptions descriptive of the one or more desired products for the purchase;
transmitting, by the processing device and to a vendor, an order for the one or more desired products for the purchase, the order comprising an indication of the one or more product descriptions; and
verifying, by the processing device, that the one or more product descriptions match one or more items available for purchase from the vendor.

2. The method of claim 1, further comprising:
transmitting, to the customer device, a confirmation that the order has been accepted by the vendor.

3. The method of claim 1, further comprising:
transmitting, to the customer device, a notification that the order has been fulfilled by the vendor.

4. The method of claim 1, further comprising:
causing the customer device to prompt the customer for clarification of at least one part of the natural-language text portion.

5. The method of claim 4, wherein the causing of the clarification is conducted in response to a determination that the at least one part of the natural-language text portion may have multiple meanings.

6. The method of claim 5, wherein the determination that the at least one part of the natural-language text portion may have multiple meanings is based at least in part on one or more of: (i) an order history of the customer; (ii) a stored listing of known product descriptions; or (iii) a stored listing of products known to be sold by a particular vendor.

7. The method of claim 1, wherein the customer device comprises a mobile telephone and wherein the receiving comprises receiving a free-form text message.

8. The method of claim 1, wherein the determining, comprises:
parsing the natural-language text portion into segments;
comparing the segments to stored listings of product descriptions; and
identifying matches between each segment and one of the one or more product descriptions.

9. The method of claim 1, wherein the verifying, comprises:
receiving, from the vendor, an indication of a comparison between a menu item description and each of the one or more product descriptions.

10. The method of claim 1, wherein the request further comprises an indication of a location associated with the customer.

11. The method of claim 10, wherein the location comprises at least one of a current location of the customer device, a future location of the customer, or a favorite location stored in association with the customer.

12. The method of claim 10, further comprising:
determining the vendor, from a plurality of available vendors, based on the location associated with the customer.

13. A method, comprising:
receiving, by a processing device and from a customer, a request for a purchase, wherein the request comprises (i) a free-form natural-language text portion, and (ii) a geo-location information portion;
determining, by a natural-language processing module and based on the natural-language text portion of the purchase request, a product description for a product;
determining, by a geo-location processing module and based on the geo-location information portion of the purchase request, a vendor to fulfill the purchase request;
transmitting, by the processing device and to the vendor, an order comprising an indication of the product description;
receiving, by the processing device in response to the transmitting and from the vendor, an indication of a corrected product description based on a menu of the vendor;
confirming, by the processing device, that the customer desires to conduct the purchase as defined by the corrected product description; and
transmitting, by the processing device and the vendor, an indication that the confirming was successful.

14. The method of claim 13, further comprising:
updating, based on the corrected product description, the natural-language processing module.

15. The method of claim 13, further comprising:
updating, based on the corrected product description, the geo-location processing module.

16. The method of claim 13, wherein the vendor comprises a first vendor and wherein the geo-location information comprises an indication of a customer preference for the first vendor in association with a first particular geographic region and a customer preference for a second vendor in association with a second particular geographic region.

17. The method of claim 16, wherein the geo-location information further comprises an indication that the customer is within the first particular geographic region.

18. A method, comprising:
determining, by a processing device, a plurality of transactions completed between customers and a merchant, wherein the transactions are descriptive of a plurality of products purchased from the merchant and wherein each product of the plurality of products is identified by a product description; and
building, by the processing device and utilizing the product descriptions identifying the plurality of products purchased from the merchant, an online menu for the merchant.

19. The method of claim 18, further comprising:
facilitating, by the processing device and utilizing the online menu for the merchant, a plurality of transactions between customers and the merchant.

20. The method of claim 18, wherein the merchant does not provide a listing of available products online.
